(19) United States
(12) Patent Application Publication
(10) Pub. No.: US 2004/0014227 A1
(43) Pub. Date: Jan. 22, 2004

(54) Apparatus, method and computer program product for automated high-throughput sampling and data acquisition

(76) Inventors: Erik D. Frederick, Durham, NC (US); Gary M. Eichenbaum, Durham, NC (US); Valery R. Polyakov, Chapel Hill, NC (US); Hendrik M. Geysen, Charlottesville, VA (US)

Correspondence Address: JENKINS & WILSON, PA, 3100 TOWER BLVD, SUITE 1400, DURHAM, NC, 27707, US

(21) Appl. No.: 10/182,885

(22) PCT Filed: Jan. 4, 2002
(86) PCT No.: PCT/US02/00064

(51) Int. Cl. G01N 35/00

(52) U.S. Cl. 436/43; 422/103; 422/67

(57) ABSTRACT

In a method, apparatus and computer program product for acquiring data from a sample, a sample or at least an initial portion thereof is transferred into an analytical instrument and the analytical instrument acquires data from the sample. While the analytical instrument is acquiring data, one or more properties of the sample are measured or the status of the system or instrumentation is considered. A determination is made as to whether the sample of the associated system or instrumentation meets one or more decision criteria (273) based on the one or more properties measured or on the status information obtained. A valve assembly (60) is_also provided that is adjustable to at least three modes operation, a sample injection/needle rinse mode, a sample loop load/instrument flush mode, and a sample loop flush/instrument flush mode.

### RELATED APPLICATIONS

This application claims the benefit of U.S. Provisional Patent Application Serial No. 60/259,758, filed Jan. 4, 2001, the disclosure of which is incorporated herein by reference in its entirety.

### TECHNICAL FIELD

The present invention relates to apparatus, methods and computer program products for implementing and controlling improved high-throughput sampling and data acquisition. More particularly, the present invention relates to valve configurations and computer software for improving such sampling and data acquisition.

### BACKGROUND ART

Drug discovery typically involves the analysis of a large number of samples in order to acquire useful data. The time period required for performing a multiple-sample analysis is thus an important criterion, as it determines the cost of the analysis as well as the sample throughput. Advances in automated engineering and computing have contributed significantly to the automation of many of the procedural steps required in carrying out sample analyses, such as sample preparation, introduction, measurement, interpretation, and cleanup. Many types of microprocessor-controlled automated devices are now commercially available for use in sampling and data acquisition. Examples of automated liquid handling devices are disclosed in U.S. Pat. Nos. 4,422,151 and 5,988,236. Accordingly, much progress has been made toward increasing sample throughput, as well as improving procedural reproducibility, reducing the level of human skill required, reducing the degree of human error, and reducing the amount of tedious human intervention required. It is well recognized by persons skilled in the art, however, that the pursuit of increased throughput is ongoing. Therefore, there remains a need for further improvements in devices and procedures employed in sampling and data acquisition.

### DISCLOSURE OF THE INVENTION

The present invention in one aspect achieves increased throughput by integrating sample delivery and data acquisition/analysis systems. In one embodiment, the present invention provides a computer software-controlled, robotic autosampling system for the rapid injection and flushing of samples into an analytical instrument such as, for example, a mass spectrometer. In a preferred embodiment, the system comprises a valve assembly, a sample injection loop, appropriate tubing and pumps, a sampling probe such as an injection needle mounted on a robotic apparatus, and the analytical instrument. The software consists of instrument controlling objects that function in a synchronous or asynchronous mode. The software controls all aspects of the sampling and data acquisition processes implemented by the system, including sample take-up, sample injection, sampling needle rinsing, sample loop flushing, and sample injection flow rate. The system provided by the invention enables an increase in sample throughput over conventional single-valve injection port-based systems.

The invention provides a novel valve assembly or system that is integrated with software to allow rapid sampling of multiple samples with minimal inter-sample delay and signal carryover. Preferably, the valve assembly is mounted to the robotic apparatus in close proximity to the sampling needle, so that the valve assembly is mounted within approximately 30 cm of any sample site of the system, and to limit dead volume to, in the non-limiting case of micro-sample delivery, less than approximately 35 μL. Preferably, a sample loop is connected to the valve assembly.

In one embodiment, the valve assembly comprises a pair of multiport valves (each including, for example, six ports). Each valve is adjustable to at least two positions. By altering the combination of respective positions of the two valves, at least three positional modes can be realized by the valve assembly. These modes are referred to herein as the sample injection/needle rinse mode, the sample loop load/instrument flush mode, and the sample loop flush/instrument flush mode. At each mode, at least two fluid flow paths can be simultaneously active. In the sample injection/needle rinse mode, a sample injection flow path and a sampling needle rinsing flow path are defined. This mode is utilized to inject a sample contained in the sample loop, while simultaneously allowing the needle to be rinsed using an appropriate pump such as a syringe pump. In the sample loop load/instrument flush mode, a sampling loop loading flow path and an instrument flushing flow path are defined. This mode allows the sample loop to be loaded from the needle using the syringe pump, while simultaneously maintaining a continuous flow of solvent to the analytical instrument. In the sample loop flush/instrument flush mode, a sample loop flushing flow path as well as the instrument flushing flow path are defined. This position allows sample injection to be interrupted without having to flush the entire sample into the analytical instrument. At an arbitrary time, the valve assembly can be switched to this position, and the remaining sample in the sample loop is diverted and flushed to waste and clean solvent is introduced into the analytical instrument at a constant rate. Preferably, at all times (i.e., during each mode), the flow of a fluid (either a sample solution or clean solvent) to the analytical instrument is maintained. In another embodiment, the valve assembly comprises a single multiport valve that is adjustable to at least three positions for realization of the three functional modes.

The valve assembly and associated autosampling system are provided in accordance with the present invention to address the needs of increased sample throughput into an analytical instrument. In practice, the invention in at least one preferred embodiment satisfies the following conditions:

a) Flow to the analytical instrument must not be interrupted between samples.

b) The injection needle or probe employed by the system must be able to be rinsed during the injection of a sample.

c) The system must be able to make a decision, based on predetermined parameters or algorithms, to dynamically abort a sample by flushing the sample to a waste line instead of through the analytical device.

In one embodiment of the invention, a sample is taken up into an injection loop and pumped into the analytical instrument through the valve system. Based on a data-driven, software-controlled decision, the sample is either flushed to waste or sampled to completion. Additionally, placement of the valve system in close proximity to the sampling needle results in increased throughput by minimizing the time required for a sample to travel between the autosampling system and the analytical instrument, as well as a reduction in deadspace.

According to one method of the invention, sample acquisition is performed by transferring a sample or at least an initial portion thereof into an analytical instrument. The analytical instrument acquires data from the sample. While the analytical instrument is acquiring data, one or more properties of the sample are measured or the status of the system or instrumentation is considered. A determination is made as to whether the sample or the associated system or instrumentation meets one or more decision criteria based on the one or more properties measured or on the status information obtained. In response to determining that the sample, system, or instrumentation has failed to meet any of the one or more decision criteria, the analytical instrument is caused to cease acquiring data from the sample or initial portion thereof. In response to determining that the sample, system, or instrumentation has met all of the one or more decision criteria, an additional portion of the sample is transferred into the analytical instrument and the analytical instrument acquires data from the additional portion.

In accordance with this method, when the decision criteria is not met, a remaining portion of the sample can be prevented from being injected into the analytical instrument. The remaining portion can be discarded or diverted away from the analytical instrument. The remaining sample can also be transferred to a suitable apparatus, such as another analytical modality.

According to another method of the invention for acquiring data from a sample. A sample is loaded into a sample reservoir such as a sample loop from a sample conduit that can include a sampling needle and associated plumbing. While the sample is being loaded an injection conduit is flushed. The injection conduit can include an analytical instrument and/or plumbing necessary for transferring the sample into the analytical instrument. At least a portion of the sample is injecting through the injection conduit into an analytical instrument. While the sample is being injected, the sample conduit is flushed. The sample reservoir is also flushed. While the sample reservoir is being flushed, the injection conduit is flushed. These steps can be repeating for additional samples.

According to another aspect of the present invention, the methods summarized hereinabove and described in more detail hereinbelow can be implemented by a computer program product comprising computer-executable instructions embodied in a computer-readable medium.

According to another embodiment of the present invention, a valve assembly for use in sample data acquisition comprises a sample loop and a valve. The valve comprises an aspiration/dispensing port, a sampling port, a waste port, a pump-side port, and an instrument-side port. The valve is selectively adjustable to at least first, second and third positions. The first position defines a sample injection flow path and a sampling probe flushing path, the second position defines a sample loop loading flow path and an instrument flushing flow path, and the third position defines a sample loop flushing flow path.

In a preferred embodiment, the sample injection flow path is directed from the pump-side injection port, through the sample loop, and to the instrument-side injection port. The sampling probe flushing path is directed from the aspiration/dispensing port to the sampling port. The sample loop loading flow path is directed from the sampling port to the sample loop. The instrument flushing flow path is directed from the pump-side injection port to the instrument-side injection port. The sample loop flushing flow path is directed from the aspiration/dispensing port, through the sample loop, and to the waste port.

According to yet another embodiment of the present invention, the valve assembly comprises a valve structure and a movable valve body. The valve structure comprises the aspiration/dispensing port, the sampling port, the waste port, the pump-side port, and the instrument-side port. The valve body comprises a plurality of internal fluid passages selectively communicating with one or more of the ports of the valve structure at the first, second and third positions.

The present invention provides embodiments of the valve assembly in dual-valve rotary, single-valve linear, and single-valve rotary configurations.

According to still another embodiment of the present invention, a sample analysis system comprises a robotic assembly, a sampling probe movably mounted to the robotic assembly, a sample loop, and a valve assembly mounted to the robotic assembly. The valve assembly comprises an aspiration/dispensing port, a sampling port, a waste port, a pump-side port, and an instrument-side port. The valve assembly is selectively adjustable to at least first, second and third positions. The first position defines a sample injection flow path and a sampling probe flushing path, the second position defines a sample loop loading flow path and an instrument flushing flow path, and the third position defines a sample loop flushing flow path. Preferably, a reversible pump such as a syringe pump fluidly communicates with the aspiration/dispensing port, a waste receptacle fluidly communicates with the waste port, an instrument pump fluidly communicates with the pump-side port, and an analytical instrument such as a mass spectrometer fluidly communicating with the instrument-side port.

It is therefore an object of the present invention to provide means for improved automated high-throughput sampling and data acquisition, in the form of an apparatus, method, and/or computer program product.

It is another object of the present invention to provide a valve assembly that is adjustable to several different positions in order to realize several operational modes by which throughput can be increased.

It is yet another object of the present invention to provide computer software for controlling such a valve assembly.

It is still another object of the present invention to provide computer software for implementing a data-driven decisional process by which a sample can be rejected or diverted prior to completion of data acquisition of that sample.

Some of the objects of the invention having been stated hereinabove, other objects will become evident as the description proceeds when taken in connection with the accompanying drawings as best described hereinbelow.

### BRIEF DESCRIPTION OF THE DRAWINGS

FIG. 1 is a schematic view of an automated sampling and data acquisition system provided in accordance with the present invention;

FIG. 2 is an exploded perspective view of a conventional multiport valve suitable for use in certain embodiments of the invention;

FIG. 3A is a schematic diagram of a valve assembly provided in accordance with one embodiment of the present invention and positioned at a sample injection/needle rinsing mode;

FIG. 3B is a schematic view of the valve assembly illustrated in FIG. 3A and positioned at a sample loop load/instrument flush mode;

FIG. 3C is a schematic view of the valve assembly illustrated in FIGS. 3A and 3B and positioned at a sample loop flush/instrument flush mode;

FIG. 4 is a partially cutaway cross-sectional view of a valve assembly provided in accordance with another embodiment of the present invention;

FIG. 5A is a schematic diagram of the valve assembly illustrated in FIG. 4 and positioned at a sample injection/needle rinsing mode;

FIG. 5B is a schematic diagram of the valve assembly illustrated in FIG. 4 and positioned at a sample loop load/instrument flush mode;

FIG. 5C is a schematic diagram of the valve assembly illustrated in FIG. 4 and positioned at a sample loop flush/instrument flush mode;

FIG. 6 is a cutaway cross-sectional view of a valve assembly provided in accordance with yet another embodiment of the present invention;

FIG. 7A is a top plan view of an upper valve structure of the valve assembly illustrated in FIG. 6;

FIG. 7B is a bottom plan view of a lower valve structure of the valve assembly illustrated in FIG. 6;

FIG. 7C is a perspective view of a valve body of the valve assembly illustrated in FIG. 6;

FIG. 8A is a schematic diagram of the valve assembly illustrated in FIG. 6 and positioned at a sample injection/needle rinsing mode;

FIG. 8B is a schematic diagram of the valve assembly illustrated in FIG. 6 and positioned at a sample loop load/instrument flush mode;

FIG. 8C is a schematic diagram of the valve assembly illustrated in FIG. 6 and positioned at a sample loop flush/instrument flush mode;

FIG. 9 is a schematic diagram illustrating an exemplary operational control environment for the system illustrated in FIG. 1;

FIGS. 10A and 10B are block diagrams illustrating a sampling and data acquisition process carried out by the present invention;

FIG. 11 is a block diagram illustrating a data-driven decisional process executed by computer software in accordance with the present invention;

FIG. 12 is a plot of intensity versus time illustrating the rapid data acquisition of multiple samples in accordance with the present invention; and

FIG. 13 is a plot of intensity versus time illustrating the throughput performance achieved by the present invention in comparison to the performance achieved by a conventional sampling and data acquisition system.

### DETAILED DESCRIPTION OF THE INVENTION

In general, the term “communicate” (e.g., a first component “communicates with” or “is in communication with” a second component) is used herein to indicate a structural, functional, mechanical, optical, or fluidic relationship between two or more components or elements. As such, the fact that one component is said to communicate with a second component is not intended to exclude the possibility that additional components may be present between, and/or operatively associated or engaged with, the first and second components.

As used herein, the terms “valve assembly” and “valve system” are taken to mean a valve unit that contains a single valve or manifold structure or a plurality of valves or manifold structures.

As used herein, the terms “rinsing” and “flushing” are used interchangeably to mean replacing a plug or volume of fluid with clean solvent and/or cleaning the inner walls of a liquid conduit by carrying away residual contaminants.

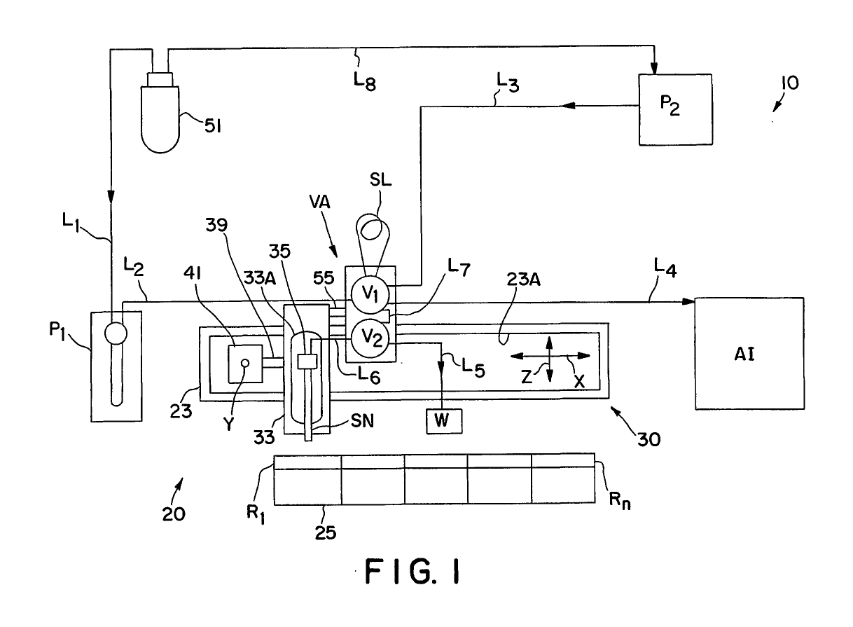

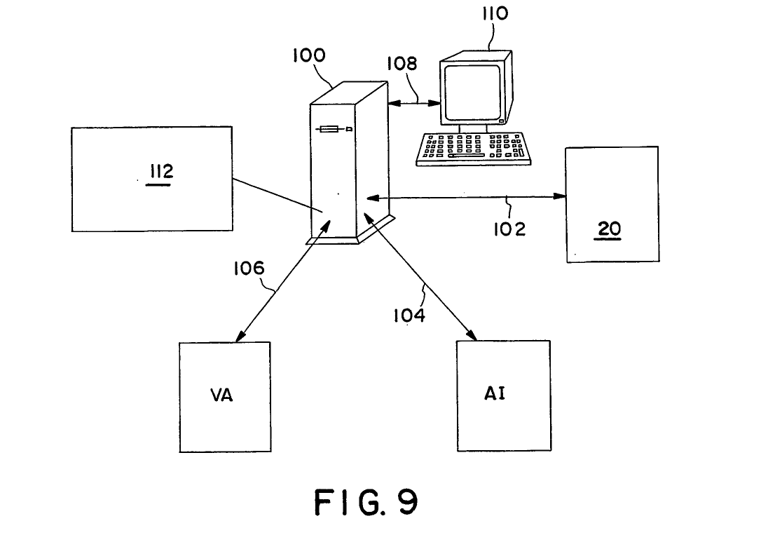

Referring now to the schematic view of FIG. 1, an automated sampling and data acquisition system, generally designated 10, is illustrated in accordance with the invention. Sampling system 10 comprises a liquid handling apparatus, generally designated 20; a valve assembly VA; one or more solvent reservoirs 51; a high-pressure pump unit P₂; an analytical instrument AI; and an electronic control unit or computer 100 with computer software 112 (see FIG. 9).

Liquid handling apparatus 20 is generally employed to perform sample preparation and liquid handling procedures, including the sequential injections of samples into analytical instrument AI. Preferably, the operations of liquid handling apparatus 20 are programmable by means of written, executable software instructions for these purposes. By way of example, liquid handling apparatus 20 comprises a main structural frame (a portion of which is designated 23) on which various operative components are supported. Preferably attached to or supported by main frame 23 is a rack assembly 25 on which a variety of different types of racks or plates R₁-Rₙ can be removably mounted. As appreciated by persons skilled in the art, racks R₁-Rₙ are usually constructed of aluminum, polypropylene, or quartz, depending on the particular application or sample composition contemplated. Racks R₁-Rₙ can be plates that include respective arrays of wells for containing sample solutions, or can include an array of holes for holding vials, test tubes, cuvettes or other types of vessels that in turn contain sample solutions. For example, each rack R₁-Rₙ could constitute a conventional 96-well microtitre plate, thereby enabling liquid handling apparatus 20 to process a large number of different samples.

It will be understood that liquid handling apparatus 20 could be an originally constructed apparatus, or could be provided as or adapted from a commercially available apparatus. One example of a suitable commercially available apparatus is a Gilson™ Model 215 Liquid Handler™ apparatus available from Gilson, Inc., Middleton, Wis. Such an apparatus, as well as other similar liquid handling apparatuses, conventionally provides an injection port for direct injection of samples into an HPLC unit or an injection module for injection of samples into a mass spectrometry unit. The standard injection port or module, however, is not required in the present invention.

Also attached to main frame 23 is a robotic assembly, generally designated 30, that is designed for electronically controlled, programmable three-axis movement. Robotic assembly 30 includes a sample aspiration and dispensing device, which preferably is provided as a sampling probe or needle SN. While conventional needles typically have a 0.03-inch bore, it is preferable that sampling needle SN used in the present invention have a 0.015-inch bore to further minimize deadspace and reduce the volume of the sample in the sample vessels required for filling a sample loop or other suitable sample reservoir. The tip of sampling needle SN can be sharpened if desired to enable penetration through the septum of a sample-holding container that is sealed in such manner. Sampling needle SN is linked to a vertical arm 33 of robotic assembly 30 by a suitable needle mounting unit or carriage unit 35. Sampling needle SN and its carriage unit 35 slide along a vertical track 33A of vertical arm 33 along a vertical direction indicated by vertical axis Z. Vertical arm 33 is linked through a suitable linkage 39 to a horizontal arm 41. Vertical arm 33 and its linkage 39 slide along a horizontal track (not shown) along a horizontal direction running into and out of the sheet of FIG. 1, as indicated by the point of horizontal axis Y. Horizontal arm 41 is linked to main frame 23 and slides along a horizontal track 23A along a horizontal direction indicated by horizontal axis X. It thus can be seen that robotic assembly 30 can be programmed to move sampling needle SN to and from various sites of liquid handling apparatus 20, including the various wells or vessels disposed on racks R₁-Rₙ as well as a rinsing station or waste receptacle W ordinarily integrally provided in some form with liquid handling apparatus 20.

Liquid handling apparatus 20 further includes a pump P₁, which can be integrated with liquid handling apparatus 20 or provided as a separate module. Preferably, pump P₁ is a syringe pump or other conventionally designed pump that is capable of reversible or two-way flow (i.e., for both aspiration and dispensing), and to which inlet and outlet liquid transfer lines L₁ and L₂, respectively, are connected. Liquid transfer lines L₁ and L₂, as well as other liquid transfer lines utilized in the practice of the invention, are usually constructed of PTFE tubing or a similarly chemically inert and flexible material. Inlet liquid transfer line L₁ communicates with one or more solvent reservoirs 51. Outlet liquid transfer line L₂ conventionally communicates directly with sampling needle SN, but in the present invention communicates with valve assembly VA as described in more detail hereinbelow.

Valve assembly VA is configured to enable the advantageous methods of the present invention as described in more detail hereinbelow. In one embodiment, valve assembly VA comprises two multiport valves V₁ and V₂ as specifically shown in FIG. 1. Alternatively, valve assembly VA comprises a single multiport valve in accordance with other embodiments of the invention described hereinbelow. Each valve V₁ and V₂ provided by valve assembly VA can be of conventional design.

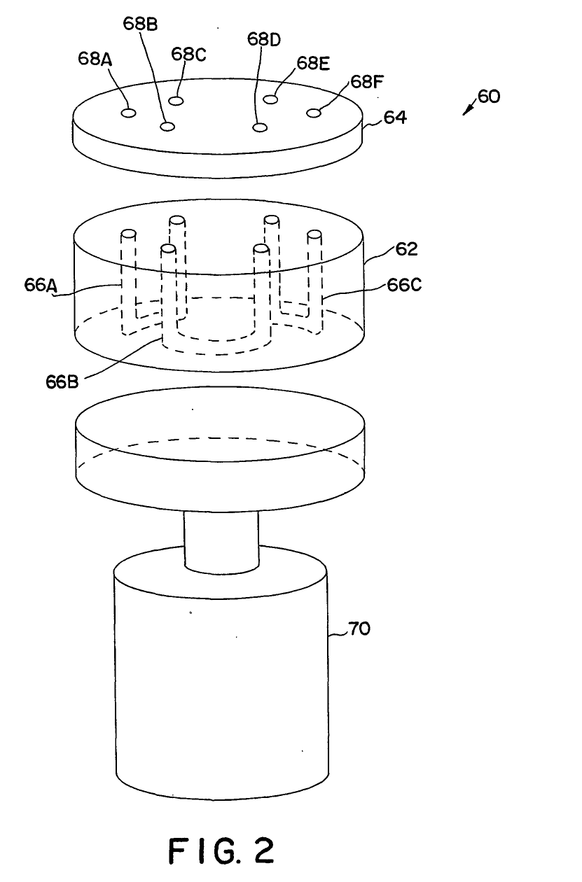

Referring to FIG. 2, a typical valve, generally designated 60, includes a rotary valve body 62 and a stationary structure such as a disk 64. Valve body 62 contains a network of internal passages 66A, 66B and 66C, and disk 64 has a plurality of ports 68A-68F that communicate with one or more of internal passages 66A-66C. Transfer tubing lines (not shown in FIG. 2) are connected to one or more of ports 68A-68F to enable fluid communication between valve 60 and the fluid circuit in which valve 60 operates along desired flow paths. Other ports 68A-68F may be plugged to prevent siphoning and entry of air into the system. Valve body 62 can be rotated in an indexing fashion by a stepper motor 70 and suitable coupling and transmission means to re-align ports 68A-68F with at least some of internal passages 66A-66C and thus switch or alter the course or courses of one or more flow paths associated with the fluid circuit. One example of a multiport valve that is suitable for use as a valve of valve assembly VA is the Rheodyne™ Model 7010 valve incorporated into the Gilson™ Model 819 Injection Module™ apparatus available from Gilson, Inc., Middleton, Wis.

FIG. 1 illustrates a preferred embodiment of the fluid circuit arrangement associated with sampling system 10 in accordance with the invention. As described hereinabove, syringe pump P₁ communicates with solvent reservoir 51 through liquid transfer line L₁, and with valve V₁ through liquid transfer line L₂. Valve V₁ communicates with high-pressure pump P₂ through a liquid transfer line L₃, and with analytical instrument AI through a liquid transfer line L₄. Valve V₁ also includes a sample loop SL, the use and operation of which are generally known in the art, or some other type of sample reservoir suitable for containing a precise volume of a liquid-phase containing substance such as a solvent or a sample carried by a mobile phase or dissolved in a solvent. Valve V₂ communicates with waste receptacle W through a liquid transfer line L₅, and with sampling needle SN through a liquid transfer line L₆. Finally, valves V₁ and V₂ communicate with each other through a fluid transfer line L₇. Valve assembly VA is mounted directly to robotic assembly 30 so as to minimize the length of fluid passages and hence the total dead volume. Preferably, valve assembly VA is mounted to vertical arm 33 of robotic assembly 30 through a suitable mounting bracket or bracket assembly 55. In the present embodiment, the dead volume is defined by the volume of sampling needle SN, the volume of liquid transfer line L₆, the volume of liquid transfer line L₇ and the internal volumes of V₁ and V₂. In the case where micro-sampling is contemplated, the total dead volume is less than approximately 35 μL, and valves V₁ and V₂ are disposed within approximately 30 cm of any sample well or vessel of racks R₁-Rₙ at any given time during operation of sampling system 10.

High-pressure pump P₂ can be any pump suitable for moving fluid at pressures normally used for injecting samples into analytical instruments. Preferably, high-pressure pump P₂ can operate at different flow rates and/or pressures. For example, high-pressure pump P₂ can be the type of pump conventionally used to inject samples into an HPLC instrument. One example of a suitable commercially available pump is a Gilson™ Model 307 isocratic pump available from Gilson, Inc., Middleton, Wis. High-pressure pump P₂ communicates with solvent reservoir 51 through a liquid transfer line L₈, or alternatively could communicate with a separate solvent reservoir (not shown).

Analytical instrument AI can be any instrument used in the art to analyze samples. In a specific application of the invention, analytical instrument AI constitutes a mass spectrometer, although the invention is not limited to such an instrument. Examples of other types of instruments suitable for use in connection with the invention include those designed to carry out optical spectrochemical analysis in the UV, visible, and IR spectra (e.g., spectroscopy and spectrophotometry). Moreover, the particular analytical instrument AI used in the present invention is not limited by any sample size restrictions. The advantages provided by the invention can be realized using an analytical instrument AI capable of either macro analysis (0.1 g or greater sample weight), semimicro or meso analysis (0.01 to 0.1 g), micro analysis (10⁻⁴ to 10⁻² g), ultramicro analysis (10⁻⁴ g or less), or ultra-trace analysis. Analytical instrument AI could be capable of performing qualitative and/or quantitative analyses. Analytical instrument AI could be capable of performing multiple-species analyses in either a sequential, simultaneous, or parallel manner. In addition, analyzing instrument AI could comprise more than one analytical modality (e.g., two mass spectrometers, a mass spectrometer and a fraction collector, and so on).

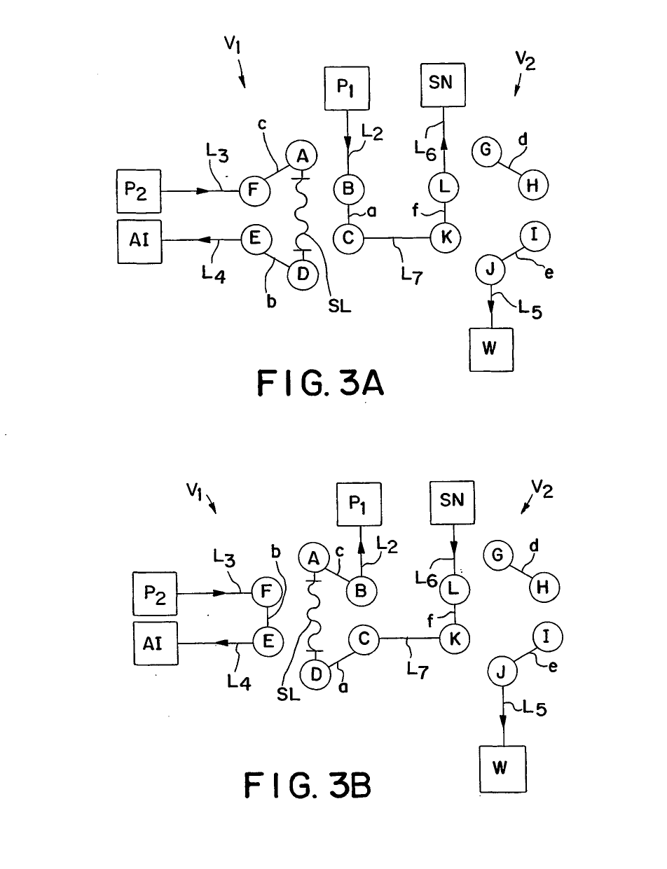

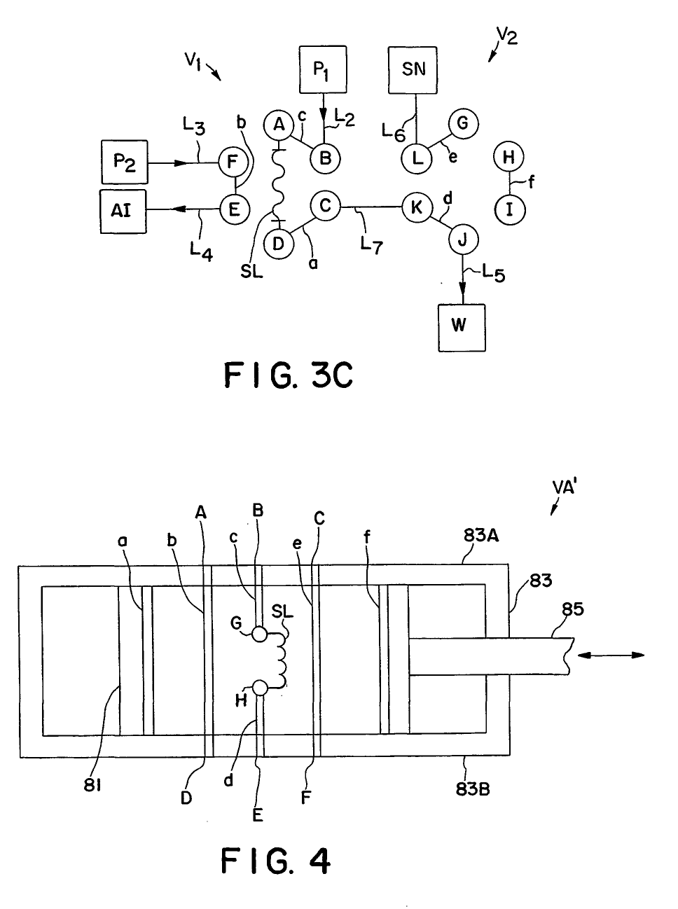

FIGS. 3A-3C illustrate three modes attainable by valve assembly VA when valve assembly VA is provided in the two-valve configuration. Specifically, FIG. 3A illustrates a sample injection/needle rinse mode, FIG. 3B illustrates a sample loop load/instrument flush mode, and FIG. 3C illustrates a sample loop flush/instrument flush mode. These modes are attained by selectively adjusting the respective rotary valve bodies of first and second valves V₁ and V₂. The adjustments have the effect of selecting which pairs of ports on each valve V₁ and V₂ become fluidly interconnected by the internal passages that rotate with their respective valve bodies, as well as which components of sampling system 10 are actively associated with the flow paths defined by the three modes. As appreciated by persons skilled in the art, the valve bodies are actuated by stepper motors or equivalent mechanisms capable of precisely indexing the valve bodies. In the present invention, the actuating movements required to effect the valve adjustments are initiated and controlled by drive signals supplied from electronic control unit 100 (see FIG. 9).

In the exemplary configurations illustrated in FIGS. 3A-3C, valve V₁ includes ports A-F and adjustable internal passages a-c, and valve V₂ includes ports G-L and adjustable internal passages d-f. The ends of sample loop SL are fluidly connected at ports A and D, respectively, of valve V₁. Liquid transfer line L₇ fluidly interconnects valves V₁ and V₂ at port C of valve V₁ and port K of valve V₂. Liquid transfer line L₂ fluidly interconnects syringe pump P₁ of liquid handling apparatus 20 with valve V₁ at port B. Liquid transfer line L₃ fluidly interconnects high-pressure pump P₂ with valve V₁ at port F. Liquid transfer line L₄ fluidly interconnects analytical instrument AI with valve V, at port E. Liquid transfer line L₆ fluidly interconnects sampling needle SN (or a suitable, alternative sample source) with valve V₂ at port L. Finally, liquid transfer line L₅ fluidly interconnects waste receptacle W with valve V₂ at port J.

Referring specifically to FIG. 3A, valves V₁ and V₂ are positioned at the sample injection/needle rinse mode. This mode enables a sample contained in sample loop SL to be injected into analytical instrument AI and, simultaneously, sampling needle SN to be rinsed with a suitable solvent. Valve V₁ is positioned such that internal passage a fluidly interconnects port B and port C, internal passage b fluidly interconnects port D and port E, and internal passage c fluidly interconnects port F and port A. Valve V₂ is positioned such that internal passage f fluidly interconnects port L and port K. In the sample injection/needle rinse mode, valves V₁ and V₂ are positioned to define two flow paths: a sample injection flow path P₂→L₃→F→c→A→SL→D→b→E→L₄→AI; and a sampling needle rinsing flow path P₁→L₂→B→a→C→L₇→K→f→L→L₆→SN.

In the sample injection flow path, a sample previously loaded into sample loop SL is injected into analytical instrument AI by moving through port D, internal passage b, port E, and liquid transfer line L₄. The sample moves and is thus injected into analytical instrument AI under the influence of high-pressure pump P₂, which creates fluid pressure in transfer line L₃, port F, internal passage c, and port A. In the sampling needle rinsing flow path, syringe pump P₁ draws solvent from solvent reservoir 51 (see FIG. 1) through liquid transfer line L₁, and pushes the solvent through liquid transfer line L₂, port B, internal passage a, port C, liquid transfer line L₇, port K, internal passage f, port L, liquid transfer line L₆, and sampling needle SN. During this mode, it is preferable that a control signal be sent to robot apparatus 30 (see FIG. 1) to position sampling needle SN at an appropriate waste receptacle, such as waste receptacle W, or a rinsing station for collection of the used solvent.

Referring specifically to FIG. 3B, valves V₁ and V₂ are positioned at the sample loop load/instrument flush mode. This mode enables a sample of precise volume to be loaded into sample loop SL and, simultaneously, analytical instrument AI to be flushed with a clean solvent. Valve V₁ has been rotated, and is now positioned such that internal passage a fluidly interconnects port C and port D, internal passage b fluidly interconnects port E and port F, and internal passage c fluidly interconnects port C and port B. The position of valve V₂ is maintained at the position shown in FIG. 3A, such that internal passage f fluidly interconnects port K and port L. In the sample loop load/instrument flush mode, valves V₁ and V₂ are positioned to define two flow paths: a sample loading flow path SN→L₆→L→f→K→L₇→C→a→D→SL→A→c→B→L₂→P₁; and an instrument flushing flow path P₂→L₃→F→b→E→L₄→AI.

In the sample loading flow path, a sample that has been drawn into sampling needle SN moves through transfer line L₆, port L, internal passage f, port K, transfer line L₇, port C, internal passage a, port D, and into sample loop SL. The sample is pulled by the vacuum induced by syringe pump P₁ through transfer line L₂, port B, internal passage c, and port A. The particular sample loaded in sample loop SL is selected by sending appropriate control signals to liquid handling apparatus 20 (see FIG. 1). As an example of the loading sequence, robotic assembly 30 is caused to move sampling needle SN into position over a selected vessel of the array of vessels contained on a selected one of racks R₁-Rₙ, after which time sampling needle SN is lowered into the selected vessel and syringe pump P₁ activated to cause the selected sample (or an aliquot thereof) to be aspirated into sampling needle SN. In the instrument flushing flow path, solvent is circulated by high-pressure pump P₂ into analytical instrument AI through transfer line L₃, port F, internal passage b, port E, and transfer line L₄. Analytical instrument AI is considered to be completely flushed when the only artifacts observed by analytical instrument AI are those characterizing the solvent used. As appreciated by persons skilled in the art, analytical instrument AI is typically equipped with means for collecting all substances it receives. For example, in the case of a mass spectrometer that ionizes incoming substances, an air handling system takes away the vapors produced by or sent through the mass spectrometer.

Referring specifically to FIG. 3C, valves V₁ and V₂ are positioned at the sample loop flush/instrument flush mode. This mode enables sample loop SL to be flushed with a suitable solvent and, simultaneously, analytical instrument AI to be flushed with a suitable solvent. The position of valve V₁ is maintained at the position shown in FIG. 3B, such that internal passage a fluidly interconnects port C and port D, internal passage b fluidly interconnects port E and port F, and internal passage c fluidly interconnects port A and port B. Valve V₂ has been rotated, and is now positioned such that internal passage d fluidly interconnects port J and port K. In the sample loop flush/instrument flush mode, valves V₁ and V₂ are positioned to define two flow paths: a sample loop flushing flow path P₁→L₂→B→c→A→SL→D→a→C→L₇→K→d→J→L₅→W; and the instrument flushing flow path P₂→L₃→F→b→E→L₄→AI described hereinabove with reference to FIG. 3B.

In the sample loop flushing flow path, syringe pump P₁ is activated to draw solvent from solvent reservoir 51 through liquid transfer line L₁ (see FIG. 1) and to push the solvent through transfer line L₂, port B, internal passage c, and port A, thereby causing a sample residing in sample loop SL to be pushed through port D, internal passage a, port C, transfer line L₇, port K, internal passage d, port J, transfer line L₅, and into waste receptacle W. As described hereinabove, the instrument flushing flow path can continue to be used to flush analytical instrument AI.

It can thus be seen that valve assembly VA is capable of loading sample loop SL while flushing analytical instrument AI, injecting the sample from sample loop SL while rinsing sampling needle SN, and flushing the remaining sample in sample loop SL to waste while flushing clean solvent into analytical instrument AI. Moreover, at each state attained by valve assembly VA, some form of fluid, whether containing a sample or a rinsing medium, is being circulated through analytical instrument AI. The operation of valve assembly VA and the rapid switching of valve assembly VA among its three modes or states significantly increases the throughput of sampling data acquisition processes as compared to, for example, conventional injection port-based systems due to the decreased inter-sample delay time needed to reach acceptable carryover requirements and the time savings realized by eliminating the injection port.

Referring now to FIG. 4, a valve assembly, generally designated VA′, is illustrated according to an alternative, single-valve embodiment of the invention. Valve assembly VA′ is a linear valve design in which a valve body 81 slides within a stationary housing structure 83. Valve body 81 is actuated by a suitable actuator (not shown, but could be, e.g., a solenoid, pneumatic cylinder, hydraulic cylinder, motor, worm drive, or the like) through a suitable arm or other linkage mechanism 85. Valve body 81 can be actuated by a reciprocating, double-acting actuator of known design, or alternatively could be actuated in alternative directions respectively by two oppositely disposed actuators (in which case an additional, oppositely disposed linkage mechanism 85 would be required). Housing structure 83 has an upper portion 83A and a lower portion 83B. Valve assembly VA′ has eight ports A-H. Upper portion 83A of housing structure 83 includes ports A, B and C, and lower portion 83B includes ports D, E and F. Valve body 81 includes ports G and H, which preferably are internally disposed with respect to housing structure 83. Valve body 81 also includes six internal passages a-f. The centermost passages, internal passages c and d, are disposed in opposing, linear alignment with each other and terminate at ports G and H, respectively. Sample loop SL is fluidly connected to ports G and H. Sample loop SL moves with valve body 81 and preferably is disposed internally with respect to housing structure 83 but could be located externally, connecting to ports G and H.

In the position of valve body 81 shown in FIG. 4, internal passage b fluidly interconnects ports A and D, internal passage c fluidly interconnects ports B and G, internal passage d fluidly interconnects ports H and E, and internal passage e fluidly interconnects ports C and F. Additionally, internal passages a and f are effectively plugged at their respective openings by upper and lower portions 83A and 83B of housing structure 83. It can be seen, however, that as valve body 81 is selectively and controllably actuated to the left and to the right, different internal passages a-f are brought into fluid communication with different ports A-F in order to alter the fluid circuit with which valve assembly VA′ is associated. As indicated in FIG. 4, internal passage c is always fluidly associated with port G and internal passage d is likewise always fluidly associated with port H.

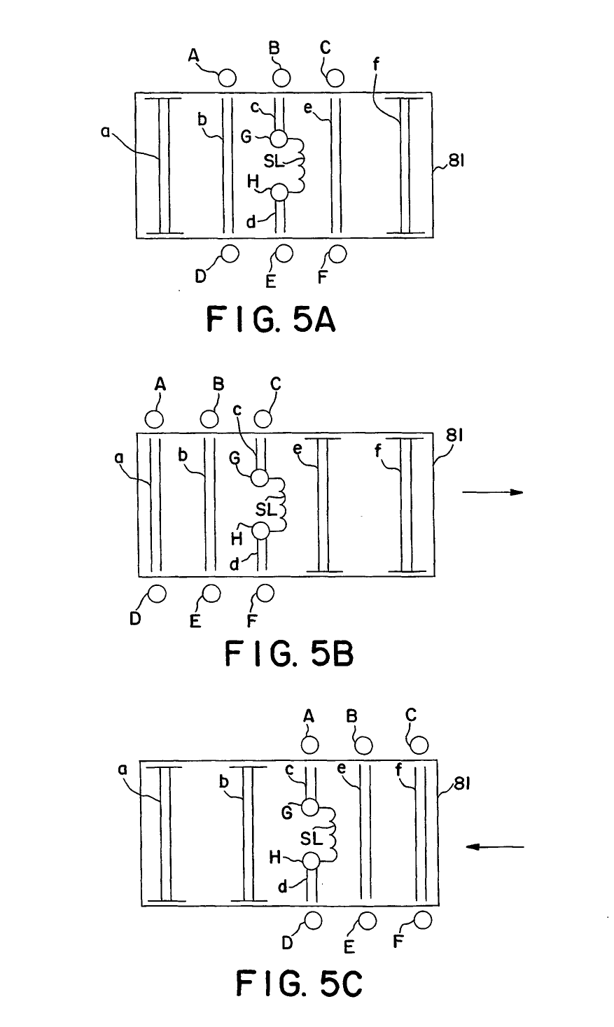

FIGS. 5A-5C illustrate the three modes attainable by valve assembly VA′ when valve assembly VA′ is provided in the linear valve configuration illustrated in FIG. 4. Specifically, FIG. 5A illustrates the sample injection/needle rinse mode, FIG. 5B illustrates the sample loop load/instrument flush mode, and FIG. 5C illustrates the sample loop flush/instrument flush mode. These modes are attained by selectively adjusting valve body 81 with respect to housing structure 83 (see FIG. 4). The adjustments have the effect of selecting which ports A-H become fluidly interconnected by internal passages a-f, as well as which components of sampling system 10 are actively associated with the flow paths defined by the three modes. In the present invention, the actuating movements required to effect the valve adjustments are initiated and controlled by drive signals supplied from electronic control unit 100 (see FIG. 9) to the actuator connected to linkage mechanism 85 (see FIG. 4).

In the exemplary configurations illustrated in FIGS. 5A-5C, fluid connections are made at ports A-H of valve assembly VA′ from various components of sampling system 10 as in the case of valve assembly VA illustrated in FIGS. 3A-3C. High-pressure pump P₂ of liquid handling apparatus 20 is connected to both ports A and B by dividing the flow through liquid transfer line L₃ into two separate flow paths respectively directed to ports A and B, using a flow splitter or tee connection and two additional liquid transfer lines (not shown). Alternatively, two separate high-pressure pumps P₂ (or a high-pressure pump and a syringe pump) and corresponding liquid transfer lines L₃ could be provided for transporting solvent through ports A and B, respectively. Liquid transfer line L₂ fluidly interconnects syringe pump P₁ with valve assembly VA′ at port C. Liquid transfer line L₅ fluidly interconnects waste receptacle W with valve assembly VA′ at port D. Liquid transfer line L₄ fluidly interconnects analytical instrument AI with valve assembly VA′ at port E. Liquid transfer line L₆ fluidly interconnects sampling needle SN or other sample source with valve assembly VA′ at port F. Sample loop SL fluidly communicates with valve assembly VA′ at ports G and H.

Referring specifically to FIG. 5A, valve body 81 is positioned at the sample injection/needle rinse mode. Valve body 81 is positioned such that internal passage a is plugged, internal passage b fluidly interconnects ports A and D, internal passage c fluidly interconnects ports B and G, internal passage d fluidly interconnects ports H and E, internal passage e fluidly interconnects ports C and F, and internal passage f is plugged. In the sample injection/needle rinse mode, valve body 81 is positioned to define two flow paths: a sample injection flow path P₂→L₃→B→c→G→SL→H→d→E→L₄→AI; and a sampling needle rinsing flow path P₁→L₂→C→e→F→L₆→SN. In the sample injection flow path, a sample previously loaded into sample loop SL is injected into analytical instrument AI by moving through port H, internal passage d, port E, and liquid transfer line L₄. The sample moves and is thus injected into analytical instrument AI under the influence of high-pressure pump P₂, which creates fluid pressure in transfer line L₃, port B, internal passage c, and port G. In the sampling needle rinsing flow path, syringe pump P₁ draws solvent from solvent reservoir 51 through liquid transfer line L₁ (see FIG. 1), and pushes the solvent through liquid transfer line L₂, port C, internal passage e, port F, liquid transfer line L₆, and sampling needle SN. During this mode, it is preferable that a control signal be sent to robot apparatus 30 (see FIG. 1) to position sampling needle SN at an appropriate waste receptacle, such as waste receptacle W, or a rinsing station for collection of the used solvent.

Referring specifically to FIG. 5B, valve body 81 is positioned at the sample loop load/instrument flush mode. Valve body 81 is positioned such that internal passage a fluidly interconnects ports A and D, internal passage b fluidly interconnects ports B and E, internal passage c fluidly interconnects ports C and G, internal passage d fluidly interconnects ports H and F, and internal passages e and f are plugged. In the sample loop load/instrument flush mode, valve body 81 is positioned to define two flow paths: a sample loading flow path SN→L₆→F→d→H→SL→G→c→C→L₂→P₁; and an instrument flushing flow path P₂→L₃→B→b→E→L₄→AI. In the sample loading flow path, a sample that has been drawn into sampling needle SN moves through transfer line L₆, port F, internal passage d, port H, and into sample loop SL. The sample is pulled by the vacuum induced by syringe pump P₁ through transfer line L₂, port C, internal passage c, and port G. The particular sample loaded in sample loop SL is selected by sending appropriate control signals to liquid handling apparatus 20 and robotic assembly 30 (see FIG. 1) as described hereinabove. In the instrument flushing flow path, solvent is circulated by high-pressure pump P₂ into analytical instrument AI through transfer line L₃, port B, internal passage b, port E, and transfer line L₄.

Referring specifically to FIG. 5C, valve body 81 is positioned at the sample loop flush/instrument flush mode. Valve body 81 is positioned such that internal passages a and b are plugged, internal passage c fluidly interconnects ports A and G, internal passage d fluidly interconnects ports H and D, internal passage e fluidly interconnects ports B and E, and internal passage f fluidly interconnects ports C and F. In the sample loop flush/instrument flush mode, valve body 81 is positioned to define two flow paths: a sample loop flushing flow path P₂→L₃→A→c→G→SL→H→d→D→L₅→W; and another instrument flushing flow path P₂→L₃→B→e→E→L₄→AI. In the sample loop flushing flow path, high-pressure pump P₂ is activated to draw solvent from solvent reservoir 51 through liquid transfer line L₈ (see FIG. 1) and to push the solvent through transfer line L₃, port A, internal passage c, and port G, thereby causing a sample residing in sample loop SL to be pushed through port H, internal passage d, port D, transfer line L₅, and into waste receptacle W. As described hereinabove, the instrument flushing flow path can be used to flush analytical instrument AI.

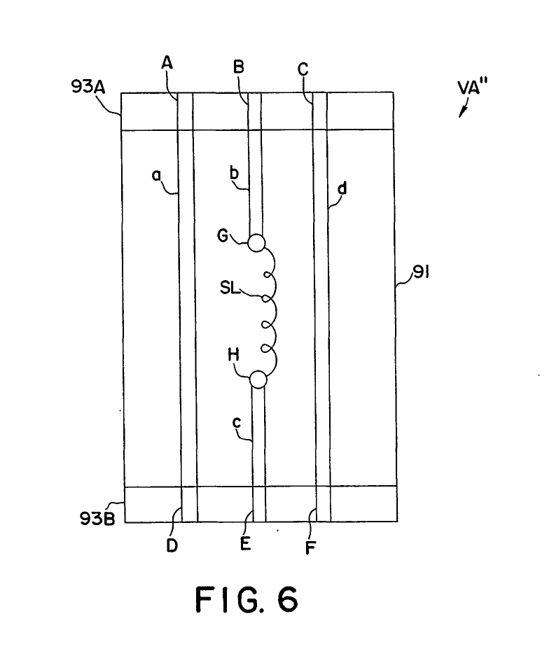

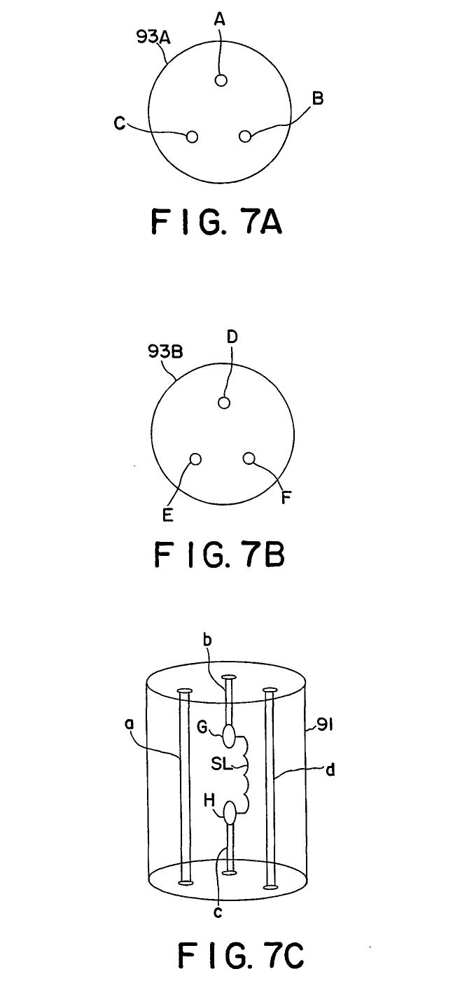

Referring now to FIGS. 6 and 7A-7C, a valve assembly, generally designated VA″, is illustrated according to another alternative, single-valve embodiment of the invention. Valve assembly VA″ is a rotary design in which a valve body 91 rotates in relation to a stationary upper valve structure 93A and a stationary lower valve structure 93B. Valve body 91 is preferably cylindrical, and upper and lower valve structures 93A and 93B are preferably disk-shaped. Valve body 91 is actuated by a suitable actuator (not shown, but could be, e.g., a solenoid, pneumatic cylinder, hydraulic cylinder, motor, or the like) through a suitable arm or other linkage mechanism (not shown). The linkage mechanism could be, for example, an endless member such as a belt that operatively engages the outer lateral surface of valve body 91, or could be a rotatable shaft that is connected to valve body 91 through a bore (not shown) in upper valve structure 93A or lower valve structure 93B. Valve assembly VA″ has eight ports A-H. Upper valve structure 93A includes ports A, B and C, and lower valve structure 93B includes ports D, E and F. Valve body 91 includes ports G and H, which preferably are internally disposed with respect to a structure (not shown) that houses valve body 91. Valve body 91 also includes four internal passages a-d. Internal passages b and c are disposed in opposing, linear alignment with each other and terminate at ports G and H, respectively. Sample loop SL is fluidly connected to ports G and H and rotates with valve body 91. As valve body 91 is selectively and controllably actuated to rotate with respect to upper and lower valve structures 93A and 93B, different internal passages a-d are brought into fluid communication with different ports A-F in order to alter the fluid circuit with which valve assembly VA″ is associated. As indicated in FIGS. 6 and 7C, internal passage b is always fluidly associated with port G and internal passage c is likewise always fluidly associated with port H.

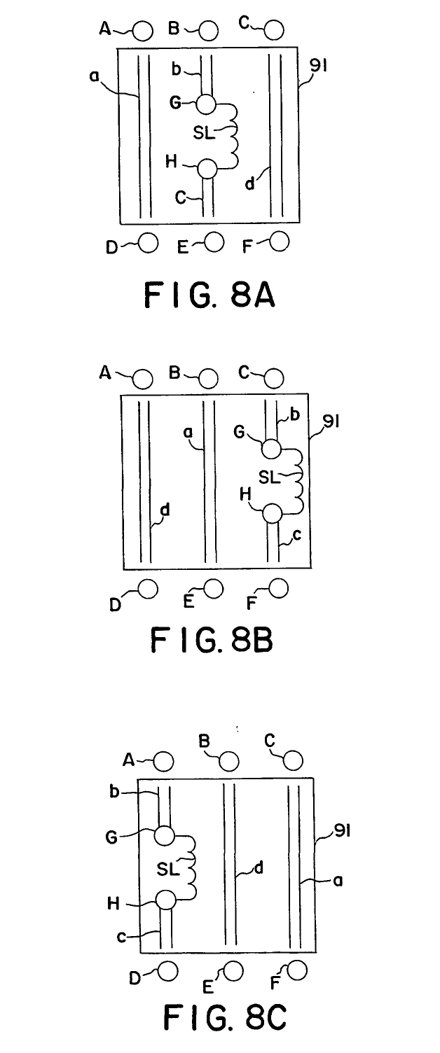

FIGS. 8A-8C illustrate the three modes attainable by valve assembly VA″ when valve assembly VA″ is provided in the rotary valve configuration illustrated in FIGS. 6 and 7A-7C. Specifically, FIG. 8A illustrates the sample injection/needle rinse mode, FIG. 8B illustrates the sample loop load/instrument flush mode, and FIG. 8C illustrates the sample loop flush/instrument flush mode. These modes are attained by selectively adjusting valve body 91 with respect to upper and lower valve structures 93A and 93B (see FIGS. 6 and 7A-7C). The adjustments have the effect of selecting which ports A-H become fluidly interconnected by internal passages a-d, as well as which components of sampling system 10 are actively associated with the flow paths defined by the three modes. In the present invention, the actuating movements required to effect the valve adjustments are initiated and controlled by drive signals supplied from electronic control unit 100 (see FIG. 9) to the actuator associated with valve assembly VA″.

In the exemplary configurations illustrated in FIGS. 8A-8C, the fluid connections made at ports A-H of valve assembly VA″ are roughly analogous to those illustrated in FIGS. 5A-5C regarding valve assembly VA′. High-pressure pump P₂ of liquid handling apparatus 20 is connected to both ports A and B by dividing the flow through liquid transfer line L₃ into two separate flow paths respectively directed to ports A and B, using a flow splitter or tee connection and two additional liquid transfer lines (not shown). Alternatively, two separate high-pressure pumps P₂ (or syringe pumps) and corresponding liquid transfer lines L₃ could be provided for transporting solvent through ports A and B. Liquid transfer line L₂ fluidly interconnects syringe pump P₁ with valve assembly VA″ at port C. Liquid transfer line L₅ fluidly interconnects waste receptacle W with valve assembly VA″ at port D. Liquid transfer line L₄ fluidly interconnects analytical instrument AI with valve assembly VA″ at port E. Liquid transfer line L₆ fluidly interconnects sampling needle SN with valve assembly VA″ at port F. Sample loop SL fluidly communicates with valve assembly VA″ at ports G and H.

Referring specifically to FIG. 8A, valve body 91 is positioned at the sample injection/needle rinse mode. Valve body 91 is positioned such that internal passage a fluidly interconnects ports A and D, internal passage b fluidly interconnects ports B and G, internal passage c fluidly interconnects ports H and E, and internal passage d fluidly interconnects ports C and F. In the sample injection/needle rinse mode, valve body 91 is positioned to define two flow paths: a sample injection flow path P₂→L₃→B→b→G→SL→H→c→E→L₄→AI; and a sampling needle rinsing flow path P₁→L₂→C→d→F→L₆→SN. In the sample injection flow path, a sample previously loaded into sample loop SL is injected into analytical instrument AL by moving through port H, internal passage c, port E, and liquid transfer line L₄. The sample moves and is thus injected into analytical instrument AI under the influence of high-pressure pump P₂, which creates fluid pressure in transfer line L₃, port B, internal passage b, and port G. In the sampling needle rinsing flow path, syringe pump P₁ draws solvent from solvent reservoir 51 through liquid transfer line L₁ (see FIG. 1), and pushes the solvent through liquid transfer line L₂, port C, internal passage d, port F, liquid transfer line L₆, and sampling needle SN. During this mode, it is preferable that a control signal be sent to robot apparatus 30 (see FIG. 1) to position sampling needle SN at an appropriate waste receptacle, such as waste receptacle W, or a rinsing station for collection of the used solvent.

Referring specifically to FIG. 8B, valve body 91 is positioned at the sample loop load/instrument flush mode. Valve body 91 has been rotated, and is now positioned such that internal passage a fluidly interconnects ports B and E, internal passage b fluidly interconnects ports C and G, internal passage c fluidly interconnects ports H and port F, and internal passage d fluidly interconnects ports A and D. In the sample loop load/instrument flush mode, valve body 91 is positioned to define two flow paths: a sample loading flow path SN→L₆→F→c→H→SL→G→b→C→L₂→P₁; and an instrument flushing flow path P₂→L₃→B→a→E→L₄→AI. In the sample loading flow path, a sample that has been drawn into sampling needle SN moves through transfer line L₆, port F, internal passage c, port H, and into sample loop SL. The sample is pulled by the vacuum induced by syringe pump P₁ through transfer line L₂, port C, internal passage b, and port G. The particular sample loaded in sample loop SL is selected by sending appropriate control signals to liquid handling apparatus 20 and robotic assembly 30 (see FIG. 1) as described hereinabove. In the instrument flushing flow path, solvent is circulated by high-pressure pump P₂ into analytical instrument AI through transfer line L₃, port B, internal passage a, port E, and transfer line L₄.

Referring specifically to FIG. 8C, valve body 91 is positioned at the sample loop flush/instrument flush mode. Valve body 91 has again been rotated, and is now positioned such that internal passage a fluidly interconnects ports C and F, internal passage b fluidly interconnects ports A and G, internal passage c fluidly interconnects ports H and D, and internal passage d fluidly interconnects ports B and E. In the sample loop flush/instrument flush mode, valve body 91 is positioned to define two flow paths: a sample loop flushing flow path P₂→L₃→A→b→G→SL→H→c→D→L₅→W; and another instrument flushing flow path P₂→L₃→B→d→E→L₄→AI. In the sample loop flushing flow path, high-pressure pump P₂ is activated to draw solvent from solvent reservoir 51 through liquid transfer line L₈ (see FIG. 1) and to push the solvent through transfer line L₂, port A, internal passage b, and port G, thereby causing a sample residing in sample loop SL to be pushed through port H, internal passage c, port D, transfer line L₅, and into waste receptacle W. As described hereinabove, the instrument flushing flow path can be used to flush analytical instrument AI.

It will be understood that sampling system 10 illustrated in FIG. 1 can be modified or reconfigured to accommodate valve assembly VA′ or valve assembly VA″. For the remainder of the present disclosure, references to valve assembly VA will be understood to also encompass valve assemblies VA′ and VA″.

FIG. 9 is a schematic diagram illustrating an exemplary operational control environment for the invention. The environment generally comprises an electronic control unit such as a computer 100 that can send output signals to and receive input signals from liquid handling apparatus 20 (including the operational components of robotic assembly 30, syringe pump P_{1,} and high-pressure pump P₂), valve assembly VA, and analytical instrument AI over suitable electronic transmission lines 102, 104 and 106, respectively (or, alternatively, by wireless means). Computer 100 can be provided as a commercially available personal computer with a standard operating system such as WINDOWS®, UNIX®, LINUX®, or the like. In addition, computer 100 preferably communicates over an electronic transmission line 108 with a peripheral user interface 110 to enable the user to input commands (e.g., by way of a keyboard) and to view output (e.g., by way of a monitor). Computer 100 processes data and instructions provided by control software 112. Control software 112 can comprise a single set of instructions, or could comprise a plurality of suitably interfaced and compatible modules or programs. For example, control software 112 could comprise several discrete objects each consisting of function-specific routines and data structures. Non-limiting examples of such objects include robotic drive, valve actuation, pump actuation, and analytic instrument control objects.

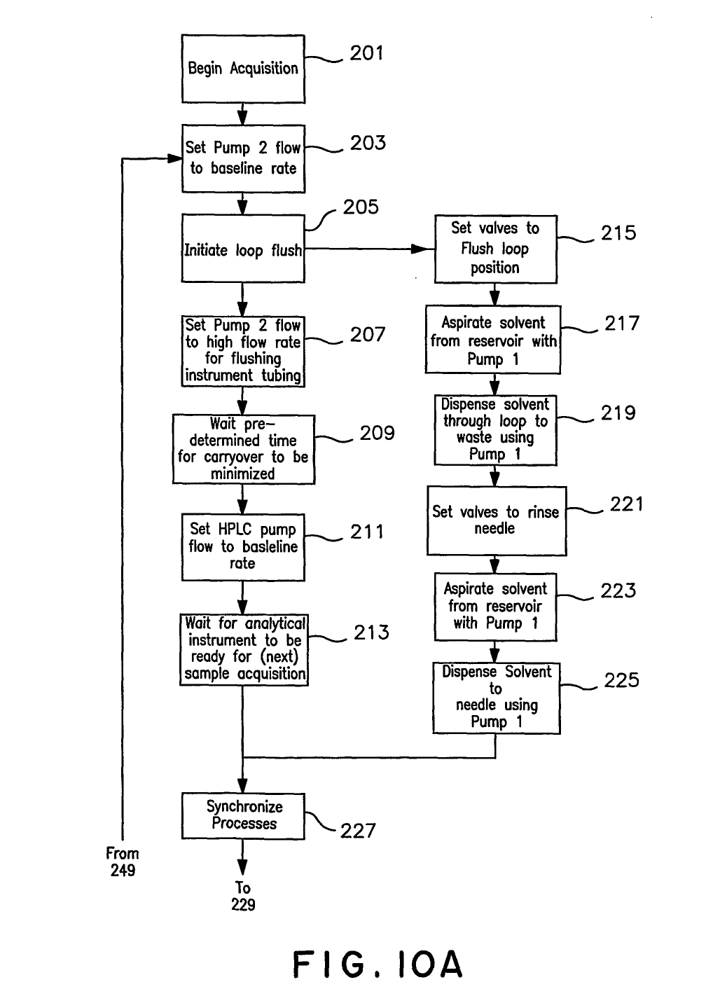

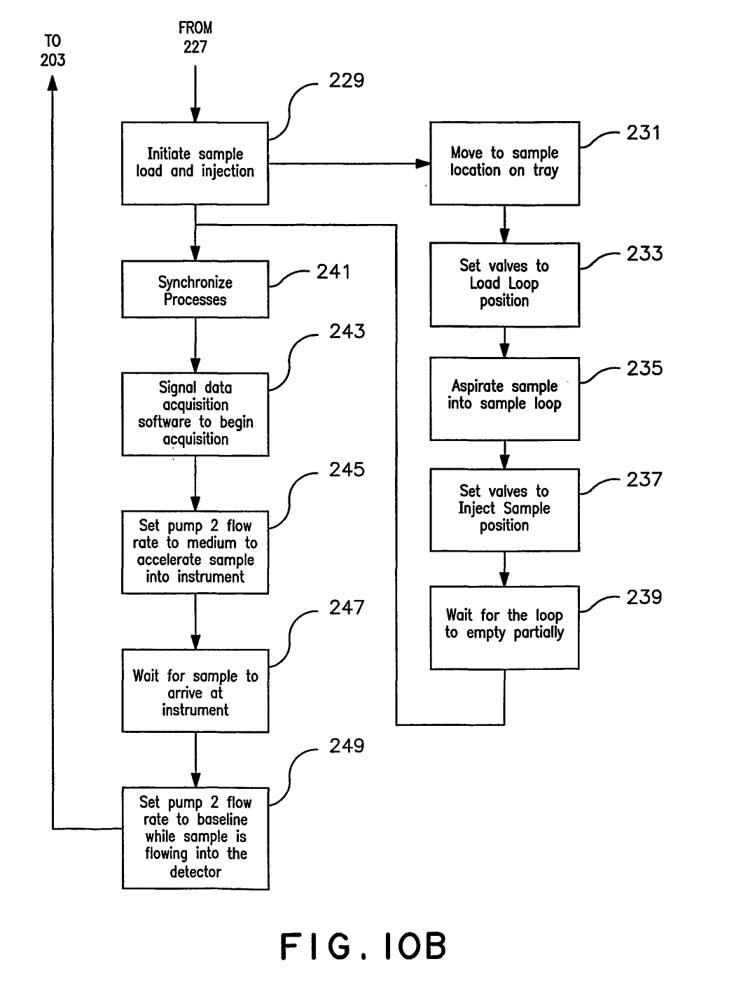

FIGS. 10A and 10B illustrate an example of a sampling and data acquisition process performed by sampling system 10 under the control of control software 112. Referring to FIG. 10A, block 201 designates the start of the sampling and data acquisition process. At block 203, high-pressure pump P₂ is set to a baseline flow rate. At block 205, signals are sent by control software 112 to liquid handling apparatus 20 and valve assembly VA to initiate the sample loop flush/instrument flush mode. At block 207, high-pressure pump P₂ is set to a high flow rate suitable for flushing the liquid lines, ports and passages that are fluidly associated with analytical instrument AI and valve assembly VA. At this point, valve assembly VA has been set to the position illustrated in FIG. 3C at which the instrument flushing flow path is defined, and solvent flows to analytical instrument AI. At block 209, solvent continues to flow to analytical instrument AI for a predetermined time so as to minimize carryover. At block 211, high-pressure pump P₂ is reset to the baseline flow rate. At block 213, solvent continues to flow through the instrument flushing flow path while control software 112 waits for analytical instrument AI to be readied for the ensuing data acquisition of a sample.

The successive events represented by blocks 215-225 occur simultaneously with the successive events represented by blocks 205-213. At block 215, valve assembly VA has been set to the position illustrated in FIG. 3C at which the sample loop flushing flow path is defined (which is the same position at which the instrument flushing flow path is defined). At block 217, syringe pump P₁ is activated to aspirate solvent from solvent reservoir 51 into the sample loop flushing flow path. At block 219, solvent flowing through the sample loop flushing flow path is dispensed through sample loop SL and into waste receptacle W under the influence of syringe pump P₁. At block 221, valve assembly VA is set to the sample injection/needle rinse mode illustrated in FIG. 3A. At block 223, syringe pump P₁ is activated to aspirate solvent from solvent reservoir 51 into the sampling needle rinsing flow path. At block 225, solvent flowing through the sampling needle rinsing flow path is dispensed through sample needle SN under the influence of syringe pump P₁. At block 227, control software 112 waits for the operations represented by blocks 205-213 and 215-225 to complete before proceeding to the following sample loading and sample injection procedures.

Referring now to FIG. 10B, at block 229, signals are sent by control software 112 to liquid handling apparatus 30, valve assembly VA, and analyzing instrument AI to initiate the sample loop load/instrument flush mode and the sample injection/needle rinse mode. At block 231, control software 112 sends a signal to robotic assembly 30 to transport sampling needle SN to predetermined coordinates that define a selected rack R₁-Rₙ and a specific sample vessel selected from the array of sample vessels located on the rack R₁-Rₙ. Once robotic assembly 30 has reached the desired coordinates, robotic assembly 30 causes the tip of sampling needle SN to enter the selected sample vessel. At block 233, valve assembly VA is set to the position illustrated in FIG. 3B at which the sample loop loading flow path is defined. At block 235, syringe pump P₁ is activated to aspirate the particular sample contained in the selected sample vessel into sampling needle SN and the sample is transferred through the sample loop loading flow path into sample loop SL. At block 237, once the sample is loaded in sample loop SL, valve assembly VA is set to the position illustrated in FIG. 3A at which the sample injection path is defined. Control software 112 sends a signal to high-pressure pump P₂ to begin injection of the sample contained in sample loop SL into analytical instrument AI. At block 239, control software 112 initiates a count based on flow rate to determine a time at which sample loop SL has been partially emptied. After this wait time has elapsed, at block 241, control software 112 waits while the respective operations of liquid handling apparatus 20, valve assembly VA, and analyzing instrument AI represented by blocks 231-239 complete in preparation for data acquisition by analytical instrument AI.

At block 243, control software 112 sends a signal to analytical instrument AI to initiate data acquisition from the sample. At block 245, control software 112 sets the flow rate of high-pressure pump P₂ to an intermediate level to accelerate the sample into analytical instrument AI. At block 247, control software 112 waits for the sample to arrive at analytical instrument AI and then, at block 249, backs the flow rate of high-pressure pump P₂ down to the baseline level while the sample is flowing into analytical instrument AI. As indicated in FIGS. 10A and 10B, this entire sampling and data acquisition cycle is repeated for the next sample.

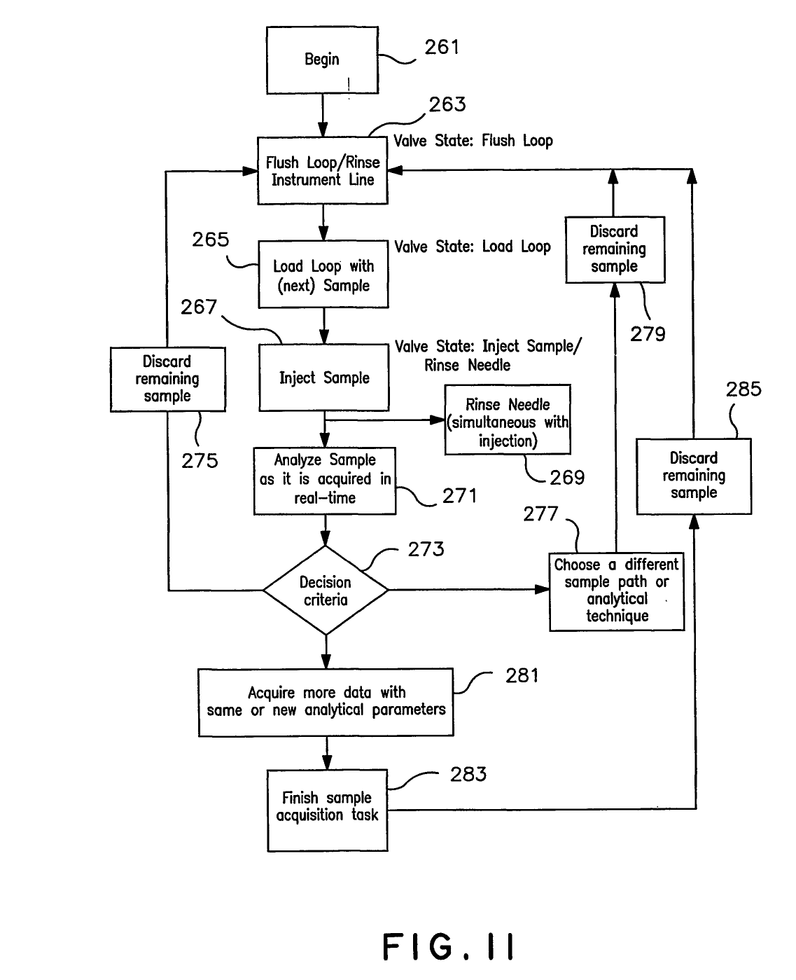

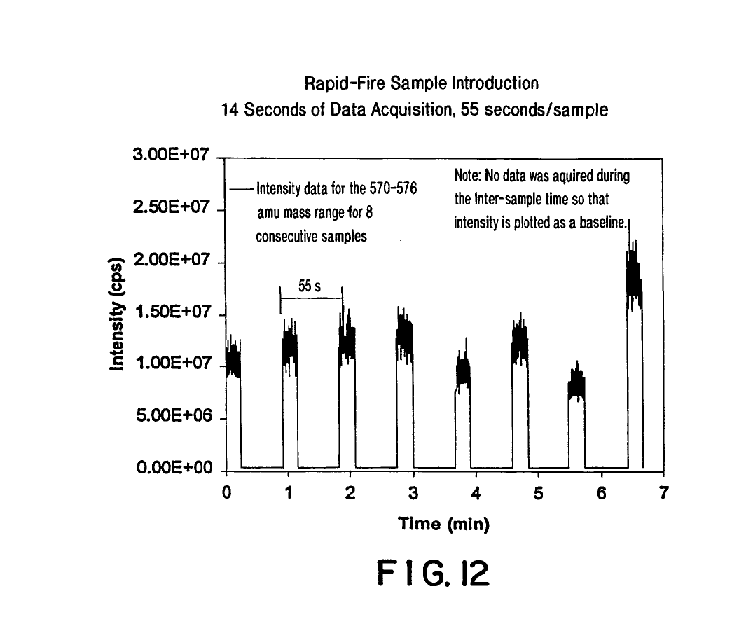

Referring now to FIG. 11, in one aspect of the method of the invention, a data-driven decisional process is provided to enhance sample throughput by enabling the sample delivery process to act on feedback received from the data acquisition/analysis process. In this data-driven decisional process, control software 112 makes decisions, such as whether to reject a particular sample during acquisition thereof, or divert a particular sample to a different sample path or analytical instrument, or permit analytical instrument AI to complete the acquisition of that sample, based on feedback from the data acquisition/analysis process. By this method, each sample is processed without the time penalties associated with conventional systems, which require the entire sample to be pumped through the system at a nominal flow rate regardless of whether or not data is to be acquired.

Block 261 designates the start of the sampling and data acquisition process, and hence is equivalent to block 201 in FIG. 10A. Block 263 designates the sample loop flush/instrument flush mode illustrated in FIG. 3C and described hereinabove. Block 265 designates the sample loop load/instrument flush mode illustrated in FIG. 3B and described hereinabove. Blocks 267 and 269 designate the sample injection/needle rinse mode illustrated in FIG. 3A and described hereinabove. At block 271, the sample (or at least an initial portion of the sample that has been introduced into analytical instrument AI) is analyzed by control software 112 in real time as it is acquired by analytical instrument AI. At block 273, control software 112 decides whether the sample, the system, and/or instrumentation thereof meets predetermined decision criteria. These criteria can include values based on certain properties of the sample and/or diagnostics or operational/functional states of the system or instrumentation. Non-limiting examples of decision criteria include insufficient sample intensity, thresholding criteria, noise criteria, criteria associated with the presence or absence of a particular peak in a spectrum, and/or criteria associated with the status of analyzing instrument AI. In general, decisions are made by comparing measured, detected, or instrumentation/system-generated values against the predetermined or stored criteria, and determining whether a pass or fail condition exists. For purposes of the present disclosure, all such values used for comparison with the decisional criteria, whether or not such values are derived from the system, its instrumentation, or the sample itself, are characterized as being properties of the sample that are obtained by taking some type of measurement of the sample.

If control software 112 determines that the sample fails to meet the decision criteria, the current method of data acquisition for that sample is terminated. In one alternative, the remaining sample residing in sample loop SL is discarded at block 275, and the process then returns to block 263, where the sample loop SL, analytical instrument AI, and all associated fluid conduits are flushed in preparation for data acquisition of the next sample. In another alternative, at block 277, control software 112 can be programmed to cause either a change in the sample injection path or a change in the analytical method to be implemented. An example of changing the sample injection path is to divert the remaining sample (i.e., that portion of the sample that has not yet been processed by or introduced into analytical instrument AI) away from analytical instrument AI to another type of instrument or device for further processing. For instance, in the case where analytical instrument AI is a mass spectrometer, the other instrument or device could be a UV spectrophotometer, a fraction collector, a liquid chromatography device, or another mass spectrometer. An example of selecting or altering a different analytical method is changing one or more settings of analytical instrument AI. For instance, in the case where analytical instrument AI is a mass spectrometer, control software 112 could cause the mass spectrometer to scan for a different range of mass/charge ratios. After the sample is further processed, it is discarded at block 279, and the process then returns to block 263, where the sample loop SL, analytical instrument AI, and all associated fluid conduits are flushed in preparation for data acquisition of the next sample.

On the other hand, if control software 112 determines that the sample meets the decision criteria, at block 281, additional data for that sample can be acquired using the same or new analytical parameters. Data acquisition for that sample is permitted to continue to completion, as indicated by block 283. As shown in FIG. 11, the remaining sample is then discarded at block 285, and the process returns to block 263, where the sample loop SL, analytical instrument AI, and all associated fluid conduits are flushed in preparation for data acquisition of the next sample.

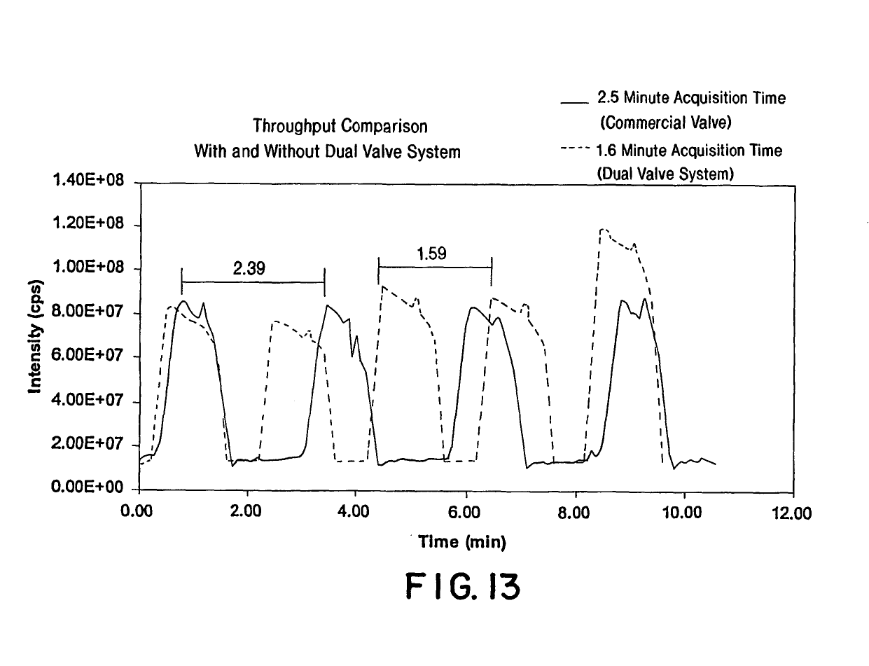

FIG. 12 illustrates a plot of intensity in counts per second (cps) versus time for a data acquisition process carried out in accordance with the present invention. For this process run, sampling system 10 illustrated in FIG. 1 was equipped with a dual-valve valve assembly VA as described hereinabove with reference to FIGS. 3A-3C and an analytical instrument AI in the form of a mass spectrometer. The intensity data was obtained for the 570-576 atomic mass unit (amu) range for eight consecutive samples. The samples were processed by the mass spectrometer in 55-second cycle times, with 14 seconds of data acquisition time at maximum intensity for each cycle. No data were acquired during the inter-sample times so that intensity could be plotted as a baseline. The results shown in FIG. 12 demonstrate the capabilities of the invention to achieve rapid-fire sample introduction without carryover.

FIG. 13 illustrates a plot of intensity versus time for a data acquisition process carried out in accordance with the present invention, in comparison to a process carried out by a conventional system. The data acquisition times using the conventional system were approximately 2:39 minutes, while the data acquisition times achieved by the present invention were approximately 1:59 minutes. FIG. 13 thus evidences an approximately 25% improvement in sample throughput by the invention over the conventional system.

It will be understood that various details of the invention may be changed without departing from the scope of the invention. Furthermore, the foregoing description is for the purpose of illustration only, and not for the purpose of limitation—the invention being defined by the claims.

What is claimed is:

1. A method for acquiring data from a sample, comprising the steps of:
(a) transferring at least an initial portion of a sample into an analytical instrument;
(b) causing the analytical instrument to acquire data from the initial portion of the sample;
(c) while the analytical instrument is acquiring data, measuring one or more properties of the initial portion of the sample;
(d) determining whether the initial portion of the sample meets one or more decision criteria based on the one or more properties measured; and
(e) in response to determining the initial portion of the sample to have failed to meet any of the one or more decision criteria, causing the analytical instrument to cease acquiring data from the initial portion of the sample, or in response to determining the initial portion of the sample to have met all of the one or more decision criteria transferring an additional portion of the sample into the analytical instrument and causing the analytical instrument to acquire data from the additional portion.

2. The method according to claim 1 wherein the initial portion of the sample is transferred into the analytical instrument from a sample reservoir.

3. The method according to claim 2 comprising the step of, prior to transferring the initial portion of the sample into the analytical instrument, loading the sample into the sample reservoir from a sample conduit.

4. The method according to claim 3 comprising the step of flushing the analytical instrument while the sample reservoir is being loaded.

5. The method according to claim 3 comprising the step of flushing the sample conduit while the initial portion of the sample is being transferred into the analytical instrument.

6. The method according to claim 5 wherein the sample conduit comprises a sampling probe.

7. The method according to claim 2 comprising the step of flushing the sample reservoir after determining whether the initial portion of the sample meets one or more decision criteria.

8. The method according to claim 7 comprising the step of flushing the analytical instrument while the sample reservoir is being flushed.

9. The method according to claim 1 comprising the steps of:
(a) transferring the sample into a sample loop from a sampling probe, wherein the initial portion of the sample is transferred into the analytical instrument from the sample loop; and
(b) rinsing the sampling probe while the initial portion of the sample is being transferred into the analytical instrument.

10. The method according to claim 1 comprising the step of, in response to determining the initial portion of the sample to have failed to meet any of the one or more decision criteria, causing a solvent to flow into the analytical instrument.

11. The method according to claim 1 comprising the step of, in response to determining the initial portion of the sample to have failed to meet any of the one or more decision criteria, preventing a remaining portion of the sample from being injected into the analytical instrument.

12. The method according to claim 11 comprising the step of discarding the remaining portion of the sample.

13. The method according to claim 11 comprising the step of diverting the remaining portion of the sample away from the analytical instrument.

14. The method according to claim 13 comprising the step of transferring the remaining sample to an apparatus.

15. The method according to claim 14 wherein the apparatus is another analytical instrument.

16. The method according to claim 11 comprising the step of altering an analytical method performed by the analytical instrument.

17. A computer program product comprising computer-executable instructions embodied in a computer-readable medium for acquiring data from a sample, the steps comprising:
(a) causing at least an initial portion of a sample to be transferred into an analytical instrument;
(b) causing the analytical instrument to acquire data from the initial portion of the sample;
(c) while the analytical instrument is acquiring data, measuring one or more properties of the initial portion of the sample;
(d) determining whether the initial portion of the sample meets one or more decision criteria based on the one or more properties measured; and
(e) in response to determining the initial portion of the sample to have failed to meet any of the one or more decision criteria, causing the analytical instrument to cease acquiring data acquisition from the initial portion of the sample, or in response to determining the initial portion of the sample to have met all of the one or more decision criteria transferring an additional portion of the sample into the analytical instrument and causing the analytical instrument to acquire data from the additional portion.

18. The computer program product according to claim 17 wherein the initial portion of the sample is transferred into the analytical instrument from a sample reservoir.

19. The computer program product according to claim 18 comprising the step of, prior to transferring the initial portion of the sample into the analytical instrument, loading the sample into the sample reservoir from a sample conduit.

20. The computer program product according to claim 19 comprising the step of flushing the analytical instrument while the sample reservoir is being loaded.

21. The computer program product according to claim 19 comprising the step of flushing the sample conduit while the initial portion of the sample is being transferred into the analytical instrument.

22. The computer program product according to claim 21 wherein the sample conduit comprises a sampling probe.

23. The computer program product according to claim 18 comprising the step of flushing the sample reservoir after determining whether the initial portion of the sample meets one or more decision criteria.

24. The computer program product according to claim 23 comprising the step of flushing the analytical instrument while the sample reservoir is being flushed.

25. The computer program product according to claim 17 comprising the steps of:
(a) transferring the sample into a sample loop from a sampling probe, wherein the initial portion of the sample is transferred into the analytical instrument from the sample loop; and
(b) rinsing the sampling probe while the initial portion of the sample is being transferred into the analytical instrument.

26. The computer program product according to claim 17 comprising the step of, in response to determining the initial portion of the sample to have failed to meet any of the one or more decision criteria, causing a solvent to flow into the analytical instrument.

27. The computer-program product according to claim 17 comprising the step of, in response to determining the initial portion of the sample to have failed to meet any of the one or more decision criteria, preventing a remaining portion of the sample from being injected into the analytical instrument.

28. The computer program product according to claim 27 comprising the step of discarding the remaining portion of the sample.

29. The computer program product according to claim 27 comprising the step of diverting the remaining portion of the sample away from the analytical instrument.

30. The computer program product according to claim 29 comprising the step of transferring the remaining sample to an apparatus.

31. The computer program product according to claim 30 wherein the apparatus is another analytical instrument.

32. The computer program product according to claim 27 comprising the step of altering an analytical method performed by the analytical instrument.

33. A method for acquiring data from a sample, comprising the steps of:
(a) loading a sample into a sample reservoir from a sample conduit;
(b) while the sample is being loaded, flushing an injection conduit;
(c) injecting at least a portion of the sample through the injection conduit into an analytical instrument;
(d) while the sample is being injected, flushing the sample conduit;
(e) flushing the sample reservoir;
(f) while the sample reservoir is being flushed, flushing the injection conduit; and
(g) repeating steps (a), (b), (c), and (d).

34. The method according to claim 33 comprising the steps of:
(a) providing a valve assembly in fluid communication with the sample reservoir, the sample conduit and the injection conduit;
(b) setting the valve assembly to a first position to enable the loading of the sample and the flushing of the injection conduit to occur simultaneously;
(c) setting the valve assembly to a second position to enable the injecting of the sample and the flushing of the sample conduit to occur simultaneously; and
(d) setting the valve assembly to a third position to enable the flushing of the sample and the flushing of the injection conduit to occur simultaneously.

35. A valve assembly for use in sample data acquisition, comprising:
(a) a sample loop; and
(b) a valve comprising an aspiration/dispensing port, a sampling port, a waste port, a pump-side port, and an instrument-side port, the valve being selectively adjustable to at least first, second and third positions, the first position defining a sample injection flow path and a sampling probe flushing path, the second position defining a sample loop loading flow path and an instrument flushing flow path, and the third position defining a sample loop flushing flow path.

36. The valve assembly according to claim 35 wherein:
(a) the sample injection flow path is directed from the pump-side injection port, through the sample loop, and to the instrument-side injection port;
(b) the sampling probe flushing path is directed from the aspiration/dispensing port to the sampling port;
(c) the sample loop loading flow path is directed from the sampling port to the sample loop;
(d) the instrument flushing flow path is directed from the pump-side injection port to the instrument-side injection port; and
(e) the sample loop flushing flow path is directed from the aspiration/dispensing port, through the sample loop, and to the waste port.

37. The valve assembly according to claim 36, wherein the sample loop comprises first and second openings, and the valve comprises a first sample loop port communicating with the first opening and a second sample loop port communicating with the second opening.

38. The valve assembly according to claim 36 comprising a valve structure and a movable valve body, wherein the valve structure comprises the aspiration/dispensing port, the sampling port, the waste port, the pump-side port, and the instrument-side port, and the valve body comprises a plurality of internal fluid passages selectively communicating with one or more of the ports of the valve structure at the first, second and third positions.

39. A valve assembly for use in sample data acquisition, comprising:
(a) a sample loop;
(b) a valve structure comprising an aspiration/dispensing port, a sampling port, a waste port, a pump-side port, and an instrument-side port;
(c) a valve body selectively adjustable to at least first, second and third positions, wherein the first position defines a sample injection flow path and a sampling probe flushing path, the second position defines a sample loop loading flow path and an instrument flushing flow path, and the third position defines a sample loop flushing flow path.

40. The valve assembly according to claim 39 wherein:
(a) the sample injection flow path is directed from the pump-side injection port, through the sample loop, and to the instrument-side injection port;
(b) the sampling probe flushing path is directed from the aspiration/dispensing port to the sampling port;
(c) the sample loop loading flow path is directed from the sampling port to the sample loop;
(d) the instrument flushing flow path is directed from the pump-side injection port to the instrument-side injection port; and
(e) the sample loop flushing flow path is directed from the aspiration/dispensing port, through the sample loop, and to the waste port.

41. The valve assembly according to claim 40, wherein the sample loop comprises first and second openings, and the valve structure comprises a first sample loop port communicating with the first opening and a second sample loop port communicating with the second opening.

42. The valve assembly according to claim 39 wherein the valve assembly has a dual-valve rotary configuration.

43. The valve assembly according to claim 39 wherein the valve assembly has a single-valve linear configuration.

44. The valve assembly according to claim 39 wherein the valve assembly has a single-valve rotary configuration.

45. A sample analysis system comprising:
(a) a robotic assembly;
(b) a sampling probe movably mounted to the robotic assembly;
(c) a sample loop; and
(d) a valve assembly mounted to the robotic assembly and comprising an aspiration/dispensing port, a sampling port, a waste port, a pump-side port, and an instrument-side port, the valve assembly being selectively adjustable to at least first, second and third positions, the first position defining a sample injection flow path and a sampling probe flushing path, the second position defining a sample loop loading flow path and an instrument flushing flow path, and the third position defining a sample loop flushing flow path.

46. The system according to claim 45 wherein:
(a) the sample injection flow path is directed from the pump-side injection port, through the sample loop, and to the instrument-side injection port;
(b) the sampling probe flushing path is directed from the aspiration/dispensing port, to the sampling port, and to the sampling probe;
(c) the sample loop loading flow path is directed from the sampling probe, to the sampling port, and to the sample loop;
(d) the instrument flushing flow path is directed from the pump-side injection port to the instrument-side injection port; and
(e) the sample loop flushing flow path is directed from the aspiration/dispensing port, through the sample loop, and to the waste port.

47. The system according to claim 45 comprising a reversible pump fluidly communicating with the aspiration/dispensing port.

48. The system according to claim 47 wherein the reversible pump is a syringe pump.

49. The system according to claim 45 comprising a waste receptacle fluidly communicating with the waste port.

50. The system according to claim 45 comprising an instrument pump fluidly communicating with the pump-side port.

51. The system according to claim 45 comprising an analytical instrument fluidly communicating with the instrument-side port.

52. The system according to claim 51 wherein the analytical instrument is a mass spectrometer.
